(19) United States
(12) Patent Application Publication
(10) Pub. No.: US 2026/0252856 A1
(43) Pub. Date: Aug. 27, 2026

(54) Amorphous Neural Networks

(71) Applicant: Anthony Luke Simon, West Bloomfield, MI (US)

(72) Inventor: Anthony Luke Simon, West Bloomfield, MI (US)

(21) Appl. No.: 19/651,731

(22) Filed: Apr. 19, 2026

Related U.S. Application Data
(63) Continuation-in-part of application No. 18/925,804, filed on Oct. 24, 2024.

(51) Int. Cl. G06N 3/047

(52) U.S. Cl. CPC G06N 3/047

(57) ABSTRACT

A neural network comprising multiple neurons including a subset of neurons comprising a majority of the multiple neurons, wherein each neuron of the subset of neurons has upstream neurons and downstream neurons connected through connections in a manner such that the connections for each neuron to other neurons are unconstrained within defined limits so that a relationship between consecutive processing layers is non-isomorphic and amorphous and is capable of at least one of learning information and outputting learned information, wherein each neuron in the subset of neurons has input connections and the input connections to the each neuron are stochastically distributed to upstream neurons at multiple upstream depths.

This patent application is a continuation in part of United States patent application Serial Number 18/925804, entitled Amorphous Neural Network Method and Structure.

### BACKGROUND OF THE INVENTION

Neural networks are used to store information through a process called training. After training neural networks can be used to retrieve the stored information. They can also be used to generalize the stored information; that is, neural networks can receive inputs that they haven’t seen during training, and provide a generalized output based upon the training. For example, a robust neural network used for image recognition can be trained on a set of images and then, based upon the training, accurately classify images that have not previously been provided to the network. In a known technique, neural networks have a structure defined by a person designing the neural network. The neural network structure specifies layers of neurons, the type of each layer, the number of neurons in each layer, and the type of neuron in each layer.

FIG. 1 shows a simplified example of a neural network 10 known in the art. In the figure, neural network 10 includes three input neurons 11 in input layer 12, neuron layers 14 and 16 comprising neurons 20, and output layer 18 with two output neurons 19 that provide two output signals represented by lines 24. The neurons 20 in layer 14 are fully connected by weights 22 to the input neurons 11, meaning each neuron 20 is connected by a weight to each input neuron 11 in layer 12. Similarly, each neuron 20 in layer 16 is fully connected to each neuron 20 in layer 12. And each output neuron in layer 18 is fully connected to the neurons 20 in layer 16.

Operation of the neural network 10 is well known in the art. In this example each input data set is represented by three pieces of information represented by input neurons 11. Each piece of information is provided as a numerical value and each is multiplied by the weights connected to the input neuron 11. The products of the multiplication of the input information and the weights are provided to the neurons in layer 14. Each neuron 20 in layer 14 sums the information provided by the set of input weights connected to that neuron and then processes that sum through an activation function which is designed to preserve the differentiability of the mathematical model represented by the neural network. A typical activation function may include a ReLU, sigmoid, tanh, or any other activation function known in the art. The output of the activation function of each neuron 20 in layer 14 is multiplied by the weight 22 connecting that neuron to each neuron in layer 16. Each neuron in layer 16 sums the products from each respective weight and the output of the neurons in layer 14 and, like the neurons in layer 14, processes that sum through an activation function to provide the output of each neuron in layer 16. The neurons in layer 16 provide their output to the weights connecting those neurons to the output neurons 19 in layer 18 and each output neuron 19 in layer 18 sums the product of the weights and the outputs of neurons in layer 16, which sum is provided to an activation function, the result of which is the output 24 for that neuron 19.

During a known technique for training, each output 24 is compared to the desired output corresponding to the specific input set provided through the input neurons 11 and, if the output is not the expected output, an error is determined and that error is fed back through the neural network in a known manner to adjust the weights 22 in the neural network. This process is repeated until the network learns the provided information set. In an example training for this network each input has three pieces of information and two expected outputs, and the network may be trained with several rows of inputs and expected outputs of this nature. The rows of information are cycled through the network and feedback is determined iteratively until the neural network learns the expected outputs for each input within a predetermined error threshold. Once the error of the outputs is reduced to a predetermined level, the neural network has learned the provided information and may be able to generalize information to provide correct outputs for information of similar type to the training information but on which the network was not trained.

In a typical neural network, information flow is provided successively through each layer by a control program that activates each layer of the neural network in sequence. Information is provided to the neural network in the input layer 12, through the weights connecting the input layer 12 to layer 14, through the weights connecting layer 14 to layer 16, and through the weights connecting layer 16 to layer 18. During training, for feedback, the error is propagated through the neural network but in the opposite direction from the output neurons 19 to the inputs 11.

In addition to the neuron layers shown, there are other known types of neural networks layers such as, for example, convolutional layers typically used for image processing. Known modifications to the basic structure shown in FIG. 1 include resnet modifications where a layer in the network may be connected not only to its prior layer but to an earlier layer in the network. Other known modifications include using bias neurons, removing weights that have small values, and randomly creating null (often referred to as dropout) neurons. Readily available software provides tools to create neural networks with this layered structure. These tools allow a neural network designer to specify the number of layers, the size of the layers, and the type of the layers when they build their neural network.

Neural networks may comprise the core information storage, processing, and generalization components of artificial intelligence systems. One challenge with large scale implementations of neural networks in large artificial intelligence systems is the amount of power consumption necessary to train the neural network which directly correlates to the cost of training the neural network and the energy used during training. The processing of a large neural network can cost $10 million or more for a single training session. For a network that needs to be updated regularly, the total training costs rapidly become greater.

It has also been suggested to grow neural networks instead of designing the neural network ahead of time. This is a field known as artificial neurogenesis. Artificial neurogenesis has been demonstrated in multiple ways. For example, a deep learning neural network can have neurons added to allow learning of new information beyond the original design and training of the network. In another example, neural networks have been grown from single neurons to learn information and for use in generalization. It has been suggested that neural networks grown through neurogenesis can learn information with fewer neurons than neural networks with a predefined layered structure.

### SUMMARY OF THE INVENTION

In an example, for a neural network including at least one neuron, a method of growing the neural network comprises providing information to the neural network for training during which training the neural network learns at least a first amount of the provided information. The method also includes detecting a limit to an information capability of the neural network. The detecting may include taking into account learning events and detecting and ignoring false limits to network learning. The method may also include determining a network growth factor. The growth factor may be responsive to a second amount of the provided information that the neural network was not able to learn and a measurement of a learning error. If the information capability of the neural network is less than a total amount of the provided information, the method may grow the neural network by adding a set comprising at least one additional neuron to the neural network. The number of additional neurons in the set may be responsive to at least the growth factor. The above steps may be repeated until the neural network learns all of the provided information. An example neural network resulting from the above steps comprises elemental neurons connected in an amorphous structure.

In an example, a neural network is provided comprising connected neurons, at least some first connected neurons providing inputs to second connected neurons, and at least some connected neurons receiving outputs from the second connected neurons. Within each connected neuron, an activation function is provided.; wherein each second connected neuron’s activation function is activated independently by the inputs provided by its first connected neurons, and wherein the neural network stores information from a training. In addition, the neural network may provide generalizations in response to neural network input signals.

In another example, a neural network is provided comprising a network of connected elemental neurons that provide a signal stream from an input to an output, wherein each connected elemental neuron includes an activation function, input weights connected to either an information input or first other elemental neurons, wherein the first other elemental neurons connected to the input weights of the each neuron are upstream neurons with respect to the each neuron and the each neuron is a downstream neuron with respect to those upstream neurons, and output connections connected to input weights of second other elemental neurons, wherein the second other elemental neurons connected to the output connections are downstream neurons with respect to the each neuron, and the each neuron is an upstream neuron with respect to those downstream neurons. In the neural network each elemental neuron is downstream with respect to its upstream neurons and upstream with respect to its downstream neurons. In addition, each elemental neuron is activated in response to completion of the activation functions of its upstream neurons. The resultant neural network is amorphous in shape and stores information from a training. In addition, the neural network may provide generalizations in an output in response to neural network input signals.

In another example, a neural network is provided comprising multiple neurons including a subset of neurons comprising a majority of the multiple neurons, wherein each neuron of the subset of neurons has upstream neurons and downstream neurons connected through connections in a manner such that the connections for each neuron to other neurons are unconstrained within defined limits so that the neural network has an amorphous shape that is not predefined within the constrained limits.

In another example, the defined limits of the above example provide a structured amorphism with at least some neurons provided in layers, wherein the neurons in each layer have a predetermined number of neurons, and wherein the unconstrained connections are randomly connected to prior layers, wherein the unconstrained connections provide the amorphous shape to the operations of the layer.

In another example, the predetermined number of neurons in each layer is selected from a random range of numbers individually for each layer, wherein the number of neurons varies between the layers.

In another example, the neural network also is a deep neural network.

In another example, the neural network also is an ultra-deep neural network.

In another example, the ultra-deep neural network has at least 100 processing layers.

In another example, the ultra-deep neural network has hundreds of processing layers.

In another example, the ultra-deep neural network has over 1000 processing layers.

In another example, the neural network has an aspect ratio higher than a classical limit.

In another example, the neural network aspect ratio is greater than 10.

In another example, the neural network aspect ratio is greater than 50.

In another example, the neural network aspect ratio is greater than 200.

In another example, the neural network is a first neural network interconnected to a second neural network that is not amorphous in shape.

In another example, the defined limits include an upstream depth range of the unconstrained connections.

In another example, a small fraction of the unconstrained connections of a neuron are beyond the defined limits, where long axon connections are created.

In another example, the matrix is structured with fluidic layers for tensor operations.

In another example, a fluidic tensor processor is provided in an amorphous neural network, wherein each tensor operation is triggered by an event of one of multiple input matrices receiving an input quota for that input matrix.

In another example, the fluidic tensor processor is an asynchronous tensor processor.

In another example, an amorphous neural network built from a predetermined reference design characterized by non-isomorphic layer relationships achieved through stochastic distribution of weights to upstream neurons across a plurality of variable upstream depths

In another example, a fluidic tensor processor is provided comprising a matrix math unit and input memory holding data form a prior output calculation in multiple causal buckets each of which is associated with a distinct fluidic layer, wherein each causal bucket is linked to a specific weight array for concurrent dispatch to the matrix math unit.

In another example, the fluidic tensor processor includes concurrent dispatch triggered asynchronously for each causal bucket and its linked weight array upon each causal bucket reaching a predetermined signal limit.

In another example, the fluidic tensor processor includes concurrent dispatch of each causal bucket and its linked weight array triggered in a predetermined order based upon a fluidic layer assignment of each causal bucket

### BRIEF DESCRIPTION OF DRAWINGS

FIG. 1 illustrates an example prior art neural network.

FIGS. 2 – 10 illustrate an example of a neural network progressively grown through artificial neurogenesis according to an example herein.

FIG. 11 illustrates example method steps for artificial neurogenesis.

FIG. 12 illustrates example method steps for adding a neuron to an amorphous neural network.

FIG. 13 illustrates example method steps to add weights to an amorphous neural network.

FIG. 14 illustrates example elemental neurons and weights and their functionality.

FIG. 15 illustrates another example of elemental neurons and weights.

FIG. 16 illustrates example operations of elemental neurons and weights when processing information.

FIG. 17 illustrates example operations of elemental neurons and weights during an example feedback for training.

FIG. 18 illustrates an example core of a structured amorphous neural network.

FIG. 19 illustrates another example core of a structured amorphous neural network.

FIG. 20 illustrates an example structured amorphous neural network.

FIG. 21 illustrates an example fluidic tensor processor.

### DETAILED DESCRIPTION OF THE INVENTION

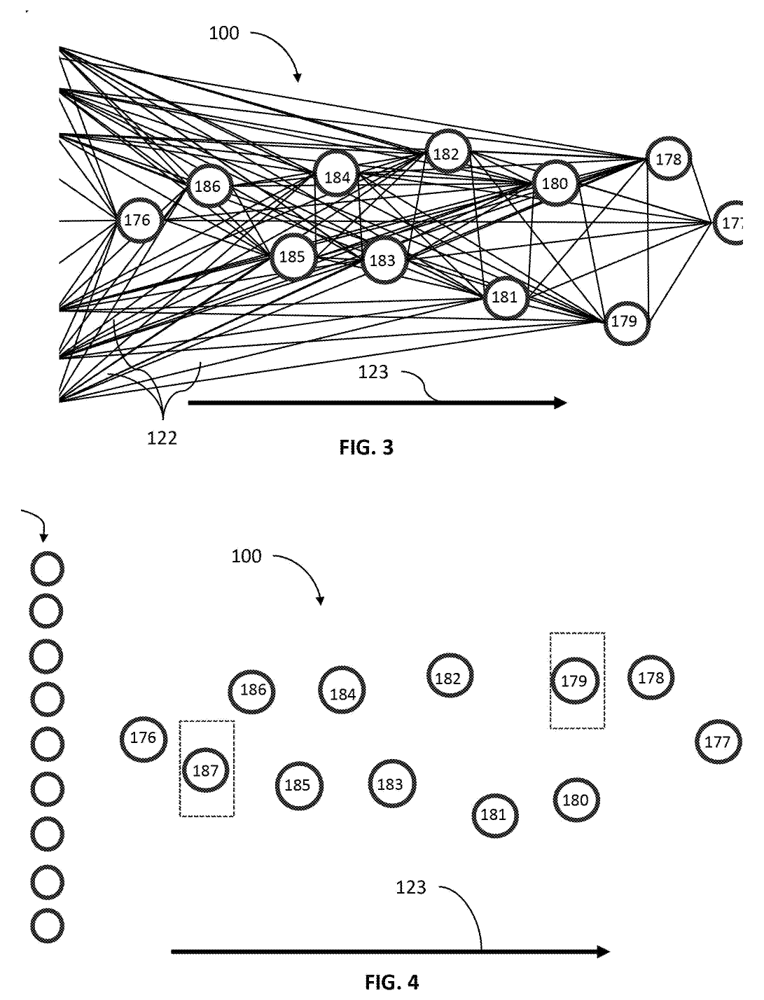

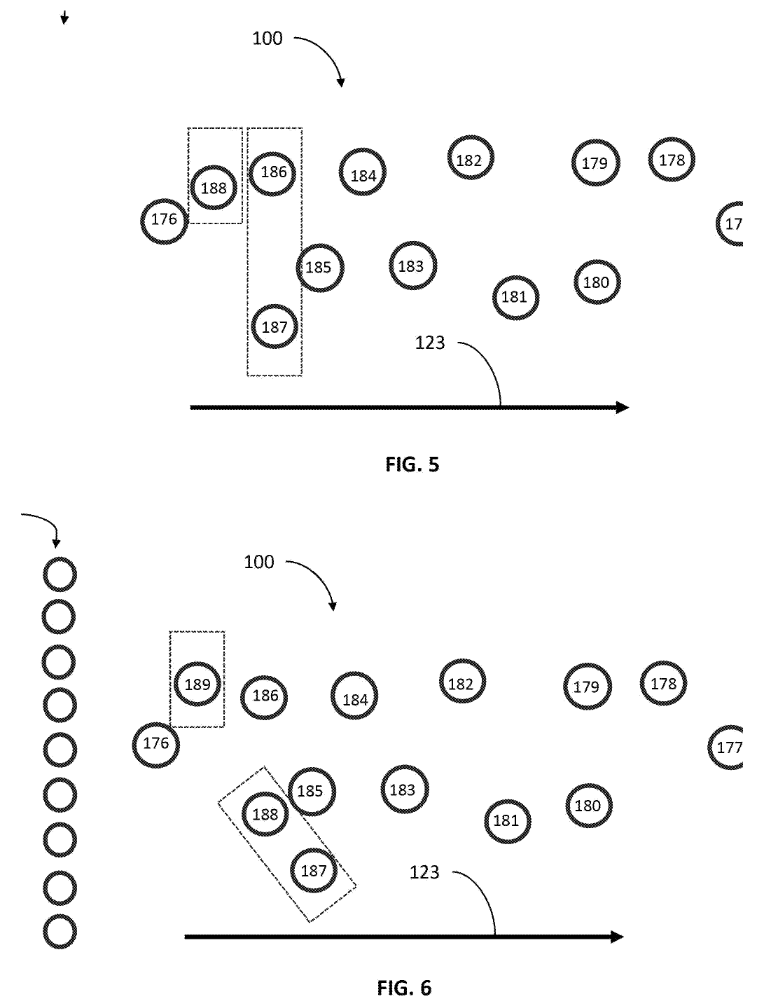

Referring now to FIG. 2, an initial or genesis neural network for learning a set of data is shown. In this example the neural network is trained and will grow to learn a set of example data (in one example, financial data). The inputs of the neural network 102 are connected by a set of weights 122 to the initial neuron 176 and the neuron 176 is connected by a weight to the output neuron 177. The neural network 100 flows information in the direction of arrow 123 for forward propagation and in the opposite direction during feedback. The input neurons 122 shown are simplified and represent an initial set of 176 input neurons providing example input financial data for the network.

In the description below, a weight 122 is sometimes referred to as a connection. The reference to the direction of information flow refers to information flow during forward propagation, unless otherwise specified. Upstream is used to refer to upstream in the direction of information flow during forward propagation and downstream is used to refer to downstream in the direction of information flow during forward propagation. The weights connecting a particular neuron to upstream neurons are referred to as the input weights for that particular neuron. The connections from a particular neuron to the weights of downstream neurons are referred to as the output connections of the particular neuron. The information provided by a particular neuron to weights connected to the information output is referred to as the output of that particular neuron and also as the input of downstream neurons connected to the particular neuron by weights. In the examples herein, the neurons are also sometimes referred to as elemental neurons. In an example, elemental neurons may move positions relative to the direction of information flow during growth of the neural network and may operate in a neural network that does not have a predetermined shape (e.g., the network does not have predefined layers of specified sizes and, for a given example neuron, input weights are connected to upstream neurons at varying depths upstream of the given neuron; in this manner the network is at least in part, amorphous). In the discussion below, when a neuron is said to add a connection, it means that the growth control program added a weight connecting that neuron to another neuron. When a neuron is said to sever or lose a connection, it means that the growth control program removed a weight connecting that neuron to another neuron. An iteration, or epoch, means the processing of all of the training data (or all of a subset of training data if using subsets) for one cycle through the neural network.

The input data set to the neural network 100 includes 176 data points for each day of data (in one example, financial data is used). In the example shown for FIGS. 2 through 9, the neural network grows as it learns 160 days of the data. In the example illustrated, each successive FIG. 3 through 9 shows new growth of the neural network that represents new learning capabilities of the neural network. After each growth the neural network learns additional days of data that it was not able to learn prior to the additional growth.

Referring now to FIG. 3, the neural network 100 is shown having grown by adding neurons 178 through 186. As can be seen the neurons 178 through 186 are not arranged in a conventional structure of layers that are fully connected. Each of neurons 178 through 186 is connected to first portions of the input neurons and not connected to other portions of the input neurons. For example, portions 101 and 105 are connected with the neurons 178 through 186 while the portion of input neurons 103 is not connected to the newly added neurons 178 through 186. Each of neurons 178 to 186 is connected to a subset of this group of neurons upstream of it. Individual neurons may be fully connected to their upstream neurons or selectively connected to their upstream neurons (meaning connected to some upstream neurons, but not others).

The arrow 123 shows the direction of information flow during forward propagation. The information starts with the input neurons 102 and flows (through the weights) to neuron 176 and also directly to the other neurons 178 to 186 to which some of the input neurons are connected. Each neuron 178 to 186 does not provide its output until all neurons upstream of it (using the direction indicated by arrow 123 as reference, the arrow pointing in the downstream direction) have processed their information. After neuron 176 processes its information, neuron 186 processes its information, then neuron 185 processes information, then in order neurons 184, 183, 182, 181, 180, 179, 178 process information, and then finally the output neuron 177 provides its output. With this configuration the neural network learned 60 of the 160 days of an example financial data set.

Referring now to FIG. 4, the next phase of the neural network growth is illustrated. In this growth phase neuron 187 is added upstream of neuron 186 and downstream of neuron 176. Also in this growth phase neuron 180 loses its connection with neuron 179 (e.g., the connecting input weight is removed) and becomes parallel in the flow of information with neuron 179. In this illustration and in the illustrations for FIGS. 5 through 9, the neuron connections (weights) are not shown to make the illustration clearer to see the positions of the neurons as the network grows, but it is understood that the neurons are connected similarly to those connections shown in FIG. 3. At the growth stage shown in FIG. 4, the neural network 100 learned 138 days of the example input financial data.

Referring now to FIG. 5, the next phase of growth of neural network 100 is shown. At this point a new neuron 188 is added downstream of neuron 176 and upstream of neuron 186. Also neuron 187 moves position in the information flow due to the severing of its connection (weight) with neuron 186 so that it is parallel with neuron 186 in the information flow. In the configuration shown in FIG. 5, the network 100 learned 147 days of the input financial data.

Referring now to FIG. 6, an additional neuron 189 is added to the network downstream of neuron 176 and upstream of neuron 186. Neuron 187 has lost a connection with neuron 185 and its position in the information flow has moved so that it is parallel with neuron 185. Additionally, neuron 188 has lost a connection with neuron 186 moving it into position in the information flow where it is parallel with neuron 186. The configuration shown in FIG. 6 learned 159 days of the input financial data.

Referring now to FIG. 7, the next growth phase of the neural network is shown with new neuron 190 added parallel in the flow of information to neuron 176.

Referring now to FIG. 8, the neural network has severed some weight connections and added some weight connections with the result that neuron 183 is now parallel in the direction of flow with neuron 182. In addition, neuron 187 has an added connection with neuron 185 and is now downstream of neuron 185. Neuron 188 has severed its connection with neuron 185 and is now parallel in the direction of information flow to neuron 185. And neuron 189 has severed its connection with neuron 186 and is now parallel in the direction of information flow with neuron 186. Finally, neuron 190 established a connection with neuron 176 and is now downstream of neuron 176 and upstream of neuron 186.

Referring now to FIG. 9, the final growth stage of this network as it learns 160 days of financial data is shown. Here neurons 179 and 180 have severed their connections with neuron 178 and are now parallel with neuron 178 in the direction of information flow. Neuron 188 has established a connection with neuron 185 and is now downstream of neuron 185 and upstream of neuron 187.

Neuron 189 has severed a connection with neuron 185 and is now parallel in the information flow with neuron 185. Similarly, neuron 190 has severed a connection with neuron 186 and is now parallel in the direction of information flow with neuron 186 and new neuron 191 is added upstream of marine 186 and downstream of neuron 176. The neural network with the neurons shown learned the 160 days set of financial information provided to the network.

In this manner, the neural network 100 shown comprises a network of connected elemental neurons 176-191, that provide a signal stream from an input 102 to the output 177. In a preferred example, each connected elemental neuron includes an activation function (described below), input weights (not shown in FIG. 9) connected to either an information input 102 or first other elemental neurons wherein the first other elemental neurons connected to the input weights of the each neuron are upstream neurons with respect to the each neuron and the each neuron is a downstream neuron with respect to upstream neurons. For example, neuron 176 is upstream with respect to neuron 191 and neuron 191 is downstream with respect to neuron 176, and so on. The neurons 176 – 191 are shown in their respective upstream and downstream positions with reference to arrow 123 showing the direction of information flow during forward propagation.

Each neuron has output connections connected to input weights of second other elemental neurons, wherein the second other elemental neurons connected to the output connections are downstream neurons with respect to the each neuron, and the each neuron is an upstream neuron with respect to the downstream neuron. Thus for example, for purpose of this description, neuron 176 is a first other elemental neuron connected to the input weights of neuron 191 and neurons 186 and 190 are second other elemental neurons connected to the output connections of neuron 191 (as are neurons 179 and neurons 179 – 189). Neurons 186 and 190 are downstream neurons of neuron 191. At each position in the information flow of the neural network, each given elemental neuron is downstream with respect to neurons that must process their outputs prior to the given elemental neuron and is upstream with respect to each neuron that cannot process its output prior to the given elemental neuron making its output available. A neuron that does not require its output to be processed prior to the given neuron processing its output and that can process its output without reliance on the output of the given neuron is neither an upstream nor downstream neuron with respect to the give neuron; instead it is parallel in the direction of information flow with the given neuron. As described below, each elemental neuron is activated in response to completion of the activation functions of its upstream neurons. The neural network 100 is amorphous in shape meaning that it is not defined by conventional layers. In a preferred example, the shape may change during training and growth. Once trained to store information, the neural network may be used to retrieve information and provide generalizations in response to neural network input signals.

To implement the amorphous neural network of FIG. 9 with conventional hardware, it may be helpful to consider the neurons arranged in virtual layers by order in which neurons can be processed parallel, also referred to as fluidic layers or processing layers. In a classical neural network, the layers define the structure of the neural network, the steps through which the network does its matrix calculations (when available, using matrix math units, such as tensor cores), and the series of geometric transformations between successive layers in the network. In a classical neuron network, the layers are guaranteed by the geometry of the neurons and calculations of each layer have complete causal dependency on the preceding layer. They also represent neuron calculations that can be done in parallel, with the sequence of the parallel operations to propagate information through the network defined by the layers. In an amorphous network, these concepts are less meaningful. There are series of calculations that can be done as a sequence of parallel operations, but each such set of parallel operations (fluidic layer) is triggered by causal readiness from upstream neurons that cannot be grouped in a “layer” – meaning all required upstream inputs have been resolved, or calculated. In an amorphous network, these parallel operations that can be done in sequence are not geometric transformations of previous layers. Instead, they are fluidic computations that emerge within an information flow that defies classical categorization. These emergent sets of parallel operations are defined as fluidic layers. The primary benefit of defining fluidic layers is to (1) identify opportunities for matrix calculations (to the extent desired), including through a fluidic tensor processor described below, (2) provide conceptual structural identity to the network (mapping the 'topological cloud' into a sequence of fluidic steps allows for architectural analysis of an otherwise non-linear system), and (3) help classify the network being used.

The example shown in FIG. 9 has eleven fluidic layers not including the input layer. The fluidic layers in order during forward propagation are as follows: (1) neuron 76, (2) neuron 191, (3) neurons 186 and 190, (4) neurons 185 and 189, (5) neuron 188, (6) neuron (187, (7) neuron 184, (8) neurons 182 and 183, (9) neuron 181, (10), neurons 178, 179, and 180, and (11) neuron 177. As will be apparent to one skilled in the art, the fluidic layers operate in reverse (from (11) to (1)) for back propagation.

Referring now also to FIG. 10, one approach to implementing the amorphous neural network in conventional hardware includes a control program that controls progress the forward and backward propagation through the network. When an input set of data from input neurons 102 is available, the control program makes that data available to the first fluidic layer, which is neuron 176. The input data may be provided through conventional computational processes, such as matrix multiplication known to those skilled in the art to multiply the input data elements by the respective input weights 105 for neuron 176 and summing the result as the hidden sum in neuron 176. This hidden sum is then operated through the activation function in neuron 176 (activation functions are well known in the art) to provide the output of neuron 176.

Once the output of neuron 176 is calculated, the control program indexes to the next fluidic layer (layer (2)), made up of neuron 191. Neuron 191 is connected to neuron 176 and a subset 103 of the input neurons 102, with the connections shown by reference 107 (also representing the input weights to neuron 191). The control program sends the output of neuron 176 and the data from input neurons 103, multiplies each by the respective input weights 107 of neuron 191, sums the result in neuron 191 as the hidden sum, and applies the activation function in neuron 191 to provide the output of neuron 191. The control program continues this way during forward propagation providing to each fluidic layer (3) – (11) the information flow through the network.

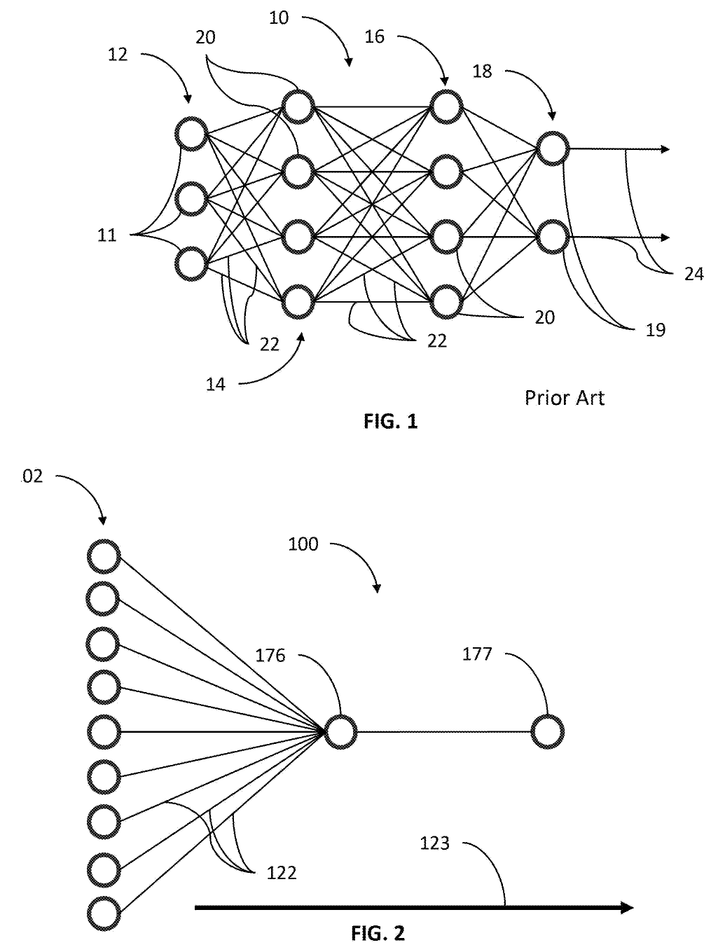

FIG. 10 helps illustrate the amorphous nature of the neural network. FIG. 10 shows example connections for neurons 176, 191, and 178, and omits the connections for the other neurons for purposes of this discussion. While neuron 176 in layer (1) is connected to all of the input neurons 102 via weights 105 in a conventional manner, neuron 191 is connected to both layer (1) neuron 176 and a portion 103 of the input neurons through weights 107. Similarly, for illustrative purposes, neuron 178 is shown with its example input weights 109. Neuron 178 is part of fluidic layer (10) and the input weights 109 connect to various neurons in prior fluidic layers including neurons 181, 182, 184, 187, 185, 186, 176, and a minor portion of input neurons 102. Using neurons 191 and 178 as examples, the difference between the neural network in FIG. 10 and the example in FIG. 1 can be readily seen. FIG. 1 illustrates a neatly defined and readily apparent layer structure of neurons and weights. On the other hand, FIG. 10 has no neatly defined or readily apparent layer structure, which is why the network in FIG. 10 is referred to as amorphous.

In contrast, a classical neural network had defined layers and the matrix multiplications between layers are a geometric mathematical process, defined by the structure of the layers. The fixed shapes of classical layers make them isomorphic. In this neural network, the processing of each fluidic layer does not have a defined geometric operation of any given prior layer. Even when these layers are executed in a defined sequence, the underlying mathematical operation remains amorphous, as each step represents a topological resolution of causal dependencies rather than a predefined or homogenous spatial transformation. Thus, from a math perspective, the operation is functionally amorphous. And in contrast to classical networks, the amorphous neural network is polymorphic or topological.

It will also be understood that neurons 191 and 178 are illustrated with their weights shown to explain the amorphous nature of the neural network. The weights for the other neurons are omitted from the illustration. It is understood that the neurons and weights in each of the layers (2) – (10) are similarly structured in that (a) they are not strictly constrained to a predefined layer structure and (b) each neuron typically connects to multiple prior layers.

If using a control program in conventional hardware, the control program also controls information flow during back propagation in the direction from layer (11) to layer (1) and the input layer to train the weights for the neural network. During back propagation, the control program controls each individual neuron in a given layer to perform its learning function when all of the neurons to which it is connected by weights in higher layers have performed their learning function. To assist in the forward and back propagation, the control program may use indexes of weight connections for each neuron. For example, for a given neuron, the control program may have (a) an index of each of the neuron’s input weights, and of each prior layer neuron to which each input weight is connected, and (b) an index of each input weight of higher layer neurons that are connected to the given neuron’s output, and each higher layer neuron for which each of these weights are the input weights. The control program may use these indexes to track completion of forward and backward propagation functions through the fluidic layers. Alternatively, the weights and neurons may be implemented in code as objects that include their connecting information. In one example, each neuron object is coded with the list of input weights and the list of weights its output is connected to. And each weight is coded with the identification of the neuron whose output is connected to the weight and the neuron whose input is connected to the weight.

Viewing the neural network in FIG. 10, the neural network comprises multiple neurons including input neurons, 102 and neurons 176 – 191. In this example, neurons 176 and 178-191 are a subset of neurons comprising a majority of the multiple neurons in the network. As described above, each of the neurons 176 and 178-191 has upstream neurons and downstream neurons connected through connections, represented by the various weights, including weights 105, 107 and 109 shown and weights not shown but understood to be there by one skilled in the art in view of the discussion above. As described above, the connections for each neuron to other neurons are unconstrained within defined limits so that the neural network has an amorphous shape that is not predefined within the defined limits. The defined limits may include (1) a maximum number of input weights per neuron, (2) a minimum number of input weights per neuron, (3) a maximum number of output connections per neuron, (4) a minimum number of output connections per neuron, and (5) variations in the aforementioned maximum and minimum numbers based upon the depth (e.g., fluidic layer) of the neuron in the network. For example, for a network performing a classification function, the maximum amount of input connections and output connections for a neuron may be reduced for neurons located more downstream in the flow of forward propagation (e.g., in higher fluidic layers). Another defined limit may be the network proximity of at least some connections of at least some neurons. For example, as the network grows in depth, new neurons or new weights (connections) added to existing neurons may have the depth of their new connections towards upstream neurons limited. For example, with reference to FIG. 10, if new weights are added to neuron 178, or if, for purposes of discussion, neuron 178 is assumed to be a newly added neuron, its input weights may be limited to connect as far upstream (in the direction of forward propagation) as neurons 186 and 190 (fluidic layer (2)), but not as far upstream as the input neurons or neurons 176 and 191. These defined constraints are illustrative in nature and are not meant to be limiting as other defined constraints may occur to one skilled in the art that provide outside boundaries within which the neural network has an amorphous shape or configuration.

As will be understood by one skilled in the art, the amorphous neural network such as shown in FIG. 10 may be a stand-alone network or a unit of a larger network. If part of a larger network, the inputs to the amorphous neural network may be outputs of an upstream network component of the larger network and the outputs of the amorphous neural network may be inputs to downstream network components of the larger network.

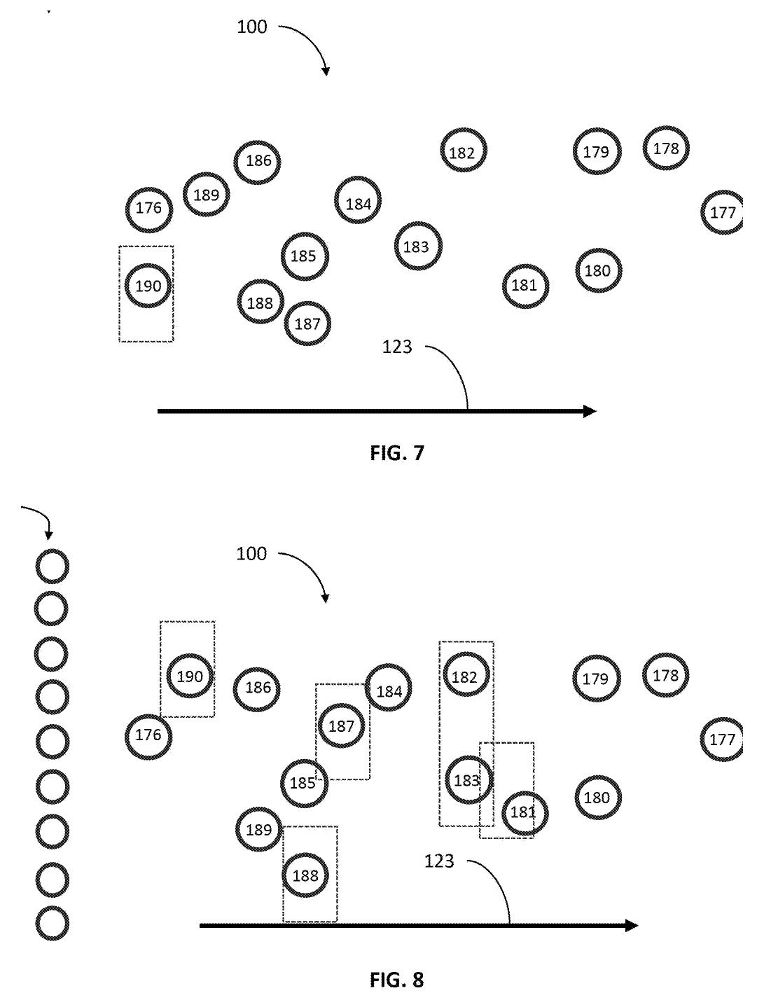

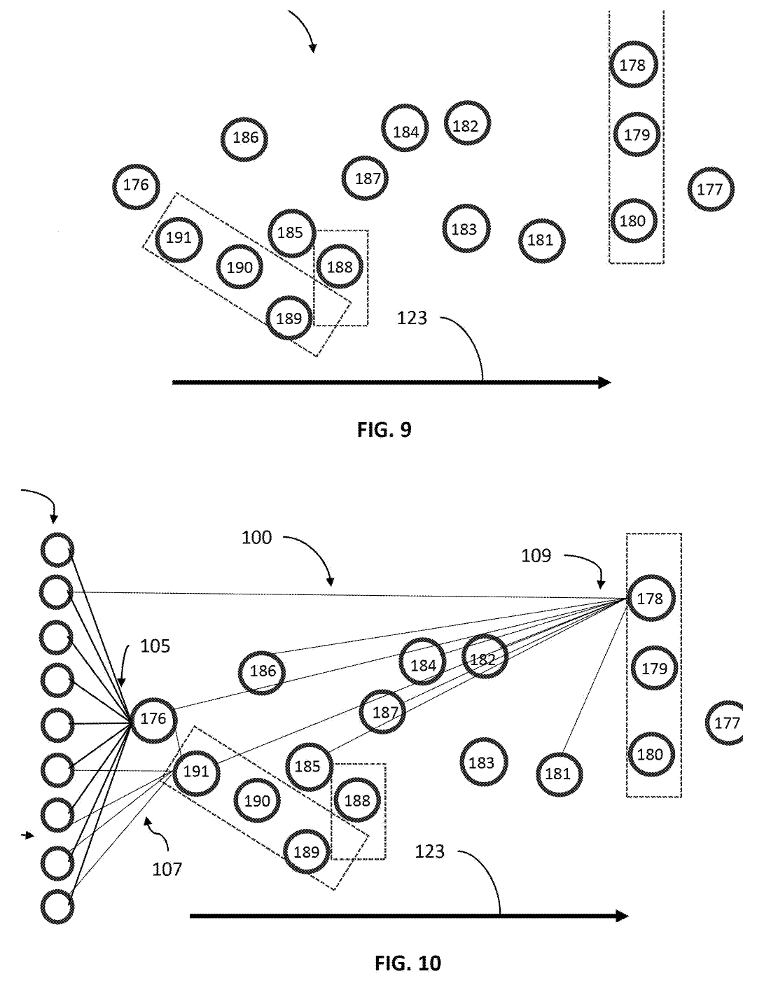

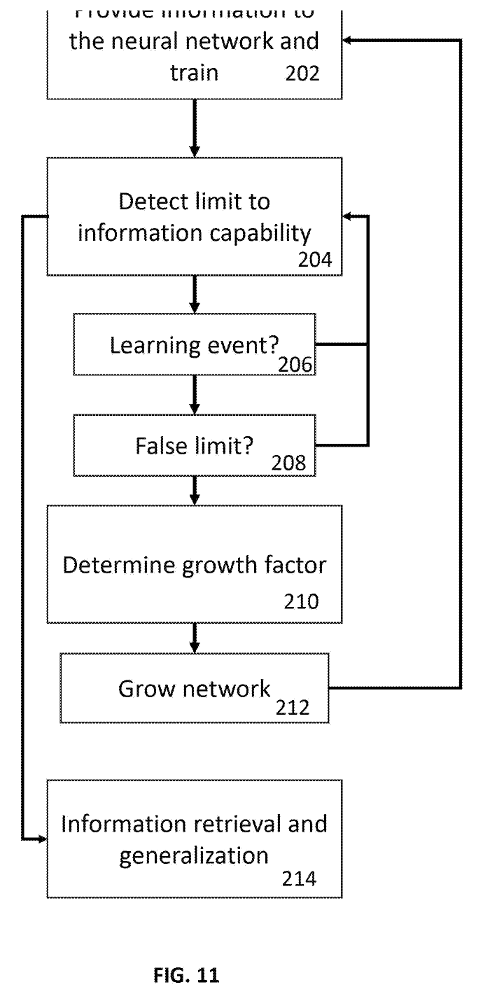

Referring now to FIG. 11, a neurogenesis method or method of growing a neural network to learn information is shown. The steps shown are performed by controls that may be implemented in hardware, software, or a combination of the two, the specific steps being within the skill in the art taking into account the explanation herein. Starting at block 202, information is provided to an infant or genesis network, such as shown in FIG. 2, for training. During the training the neural network learns up to a first amount of the provided information. During this step shown in block 202 the training is of the type appropriate for the type of neural network being built. One example includes supervised learning. Another example includes unsupervised learning, such as when building an autoencoding neural network.

At step 204 the neural network detects the limit of the information capability of the network. As is known in the art, during learning a neural network has an error for each piece of information to learn and a total error for the total information set. Generally, detecting a limit in the information capability of the network may include detecting that the network has reached a learning limit which may be indicated by the total error of the network reaching a plateau at which it does not fall below. A learning limit may also be indicated by the network plateauing in the number of information items (e.g., in the financial example above, a certain number of days of information) that the network learns to a predetermined error.

Moving now to step 206, the network during learning and detection determines whether it is in the middle of a learning event. A learning event may occur such as when the network has changed due to the growth, or neurogenesis. For example, when new neurons are added to the network, it may cause a temporary disruption and the total error of the network may temporarily increase until the network adjusts to the new neurons and begins learning additional information based on the additional capability that the additional neurons provide to the network. A learning event may also occur if the neural network has had a structural change due to addition or subtraction of connections, or weights, which interconnect the neurons. One method for addressing the learning event is to prevent step 204 from signaling a limit to the network information capability, or to override step 204, for a period of learning iterations of the neural network after the occurrence of the learning event. This override will allow the neural network to recover from any disruption that the learning event may have introduced and continue learning new information until the learning limit is reached.

Also during learning, step 208 illustrates the detection of whether the neural network has reached a false limit and if so, the neural network will not indicate a limit to the information capability of the network. For example, it is not unusual for a neural network during learning to reach lows in total error or pauses in the reduction of total error, and for the total error to temporarily rise as the neural network adjusts itself to learning the information set. False limits may be temporary in nature in which case they may be detected and addressed by prohibiting the step 204 from signaling a limit to the learning capability of the network unless that limit is sustained for a predetermined number of iterations of the network. Accordingly, if a learning event is detected at step 206 or a false information limit is detected at step 208, the method does not determine that the neural network has reached the limit of its information capability and continues the learning cycle.

If step 204 determines that the neural network has reached the limit of its information capability and is not in a learning event as determined by step 206 or at a false limit as determined by step 208, step 210 determines a growth factor for the neural network.

The growth factor at step 212 can be represented as a number and may be determined by one or more of the following factors: the amount of information learned by the neural network compared to the total information in the input information set, the size of the error at which the neural network stopped learning, and the size of individual errors for information sets (e.g., in the example of financial data above, the size of error for individual days of data). Once the growth factor is determined at step 210 the method grows the neural network at step 212 by adding neurons to the network. The addition of neurons to the network may be done in a variety of manners. In one example, neurons are added to the most active connections in the network. The active connections in one example may be indicated by the size of the weights connecting the neurons, with larger weights potentially indicating a larger impact of that connection on the neural network. Active connections in another example may be determined by the total number of active weights connected to a neuron. In another example, the network can be grown by randomly adding neurons and connections in the network. When weights are added to the neural network, either to connect new neurons into the network or to add additional weights to existing neurons, their starting values of the weights may be determined randomly, such as, for example, randomly selecting a value between 0 and 1 for each weight. The weight starting values may be determined through other means and need not be randomly determined. It is preferred to have a variety of initial values in a new weight set and it is preferred that a neuron not be duplicated with its weights as identical reproductions to weights of the existing neuron in a manner that may make the original and new neuron behave in lockstep with each other. After the network is grown at step 212, the processes represented by steps 202 and 204 are continued repeatedly, including steps 206, 208, 210 and 212, as necessary until the neural network is capable of learning the entire information set.

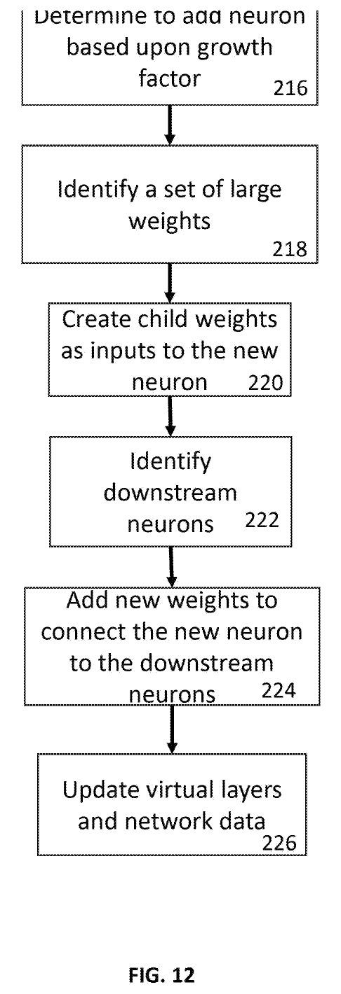

FIG. 12 illustrates example steps of adding a neuron to the network. At step 216, the method determines to add a neuron, for example, based upon the growth factor determined at step 210 in FIG. 11. At step 218, the method indexes through the various weights and identifies a set of weights that have relatively large values. Alternatively, the weights can be selected randomly. For each weight identified at step 218 (each referred to as a parent weight), a new weight is created at step 220; the new weight is referred to as a child weight. The child weight connects to the same neuron output to which its parent weight connects and serves as an input weight to the new neuron. Once the input weights are determined, step 222 identifies neurons that are downstream of the neurons that are upstream (in the direction of forward propagation) of the new neuron. From the set of downstream neurons, a subset is selected (unless the set is very small, in which case all may be selected). The selected downstream neurons can be determined at random or by a qualitative factor, such as the neurons with the least number of input weights. At step 224, the method creates a new input weight for each of the selected downstream neurons and connects that weight to the output of the new neuron. Once this step is completed, the control program updates the network information and the network can return to training (step 202 in FIG. 11).

If a control program is used with conventional hardware, the control program updates the fluidic layers and the indices identifying connections between neurons. The fluidic layers may be identified as follows: (a) during forward propagation, neurons that have input weights connected solely to the input neurons are fluidic layer (1); (b) neurons that have input weights connected solely to fluidic layer (1) neurons and the input layer are fluidic layer (2); (c) neurons that have input weights connected solely to fluidic layer (2) neurons and neurons upstream of fluidic layer (2) are fluidic layer (3) neurons, etc. Each successive fluidic layer (e.g., (4), (5) …) is determined in the same manner and generically defined as relying upon the output of at least one neuron of its prior fluidic layer and 0 to n neurons of further upstream fluidic layers (where n is <= the total number of neurons in the upstream layers). When the fluidic layers are determined after growth of the network, preexisting neurons may no longer be in the same fluidic layers they were previously and thus may have appeared to have moved to a different fluidic layer.

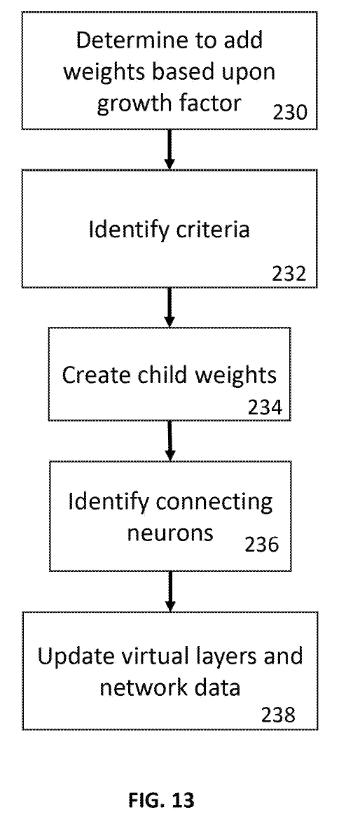

Referring now to FIG. 13, in addition to, or in alternative to the steps for adding new neurons, the method may add weights to the neural network in response to the growth factor. The steps for adding weights start at step 230 where the growth factor determines to add new weights. This determination may be made automatically when new neurons or added, in response to a desire to make smaller increments in learning capability of the network, or based upon the weight to neuron ratio. The locations in the network to add weights may be determined by a variety of criteria. Neurons can be selected randomly, or weights can be added based upon the numeric size of inputs or outputs of neurons. For example, if a neuron typically has a large output value but connects to a limited number of downstream neurons, a new weight can be added connecting that neuron to the additional downstream neurons. The new weights are called child weights and are added to the neurons identified (step 234) by one of the aforementioned approaches. The other neuron connection of each child weight may similarly be selected by a variety of approaches at step 236. If the child weight is already associated to an input of an existing neuron (parent neuron), the child weight is connected to the output of another neuron of equal or lower (upstream) fluidic layer as the parent neuron. If the child weight is already associated with an output of an existing neuron (parent neuron), the child weight is connected to the input of another neuron of equal or higher (downstream) fluidic layer as the parent neuron. This other neuron to which the child weight is connected may be selected randomly or by a qualitative factor such as, the number of input or output connections of that neuron, or the value of the hidden sum or output of a neuron. For example, a child weight added to the output of a parent neuron that has a high output value may be added to the input of a neuron that has a relatively low output value. The result of steps 234 and 236 is the addition of the new weight. After the desired weights are added, the network data and fluidic layers are updated (step 238) in the control program and the network resumes training (step 202 in FIG. 11).

In an example, the neural network may actively grow and trim connections (weights) during growth and learning. Weights may be trimmed, or removed, if they have values insignificant compared to other weights connected to a particular neuron. Weights may be added to either output connections or as input weights to a neuron if (a) there are candidate neurons to add connections to (e.g., neurons not already connected to the particular neuron) and (b) the number of weights or connections to a particular neuron is less than a determined number. The total number of weights or connections for a particular neuron may be a function of where the neuron is in the information flow. For example, neurons closer to the input information may have a determined maximum number for input weights greater than those closer to the output of the neural network, keeping in mind that strict conformity to this determination is not necessary and there may be benefits to introducing a level of randomness in this determination.

Referring again to FIG. 11, if at step 204 the method determines that the neural network has grown to a capability to learn the entire information set, the method proceeds to step 214, where the neural network is used for information retrieval and generalization. As is known in the art the neural network may be used as a standalone information retrieval and generalization function or maybe combined into larger structures for more complex AI tasks known to those skilled in the art.

Using the network in information retrieval and generalization may involve moving the weights and neuron structures to new hardware as is known in the art, for example, hardware dedicated to information retrieval and generalization and not needing the functionality of training. Information is retrieved from the network by providing an input information set that forward propagates through the network to the output, which is the retrieved information. Generalization occurs in a similar manner, except the information provided to the network is of a category similar to the information on which the network is trained but not identical to the training information. The output of the network may be, for example, a categorization (e.g., of an image or other type of data) of the input data.

In an example, the above process is carried out by introducing the information or data to the network in subsets. Thus in the example of training 160 days of financial data, an initial number of days of data or information less than 160 is used to train and grow the network. The number of days of data or information is increased in increments as the network learns the subsets of information presented to it during training until the network has grown and learned the entire data set.

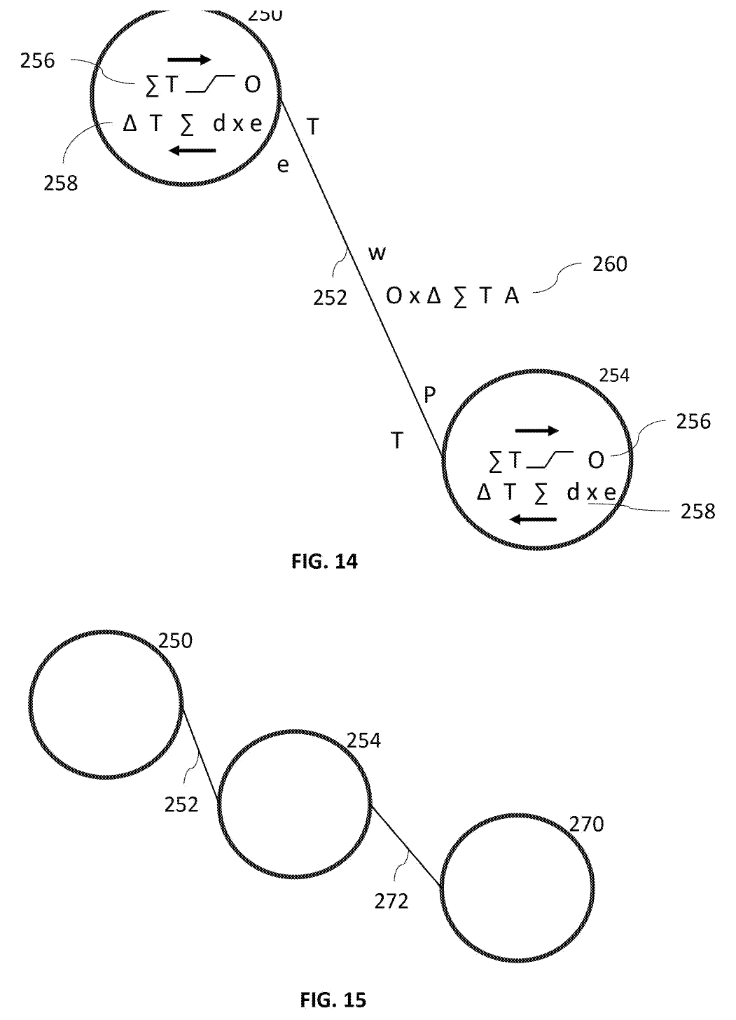

Referring now to FIG. 14, example structure within a neural network is shown in a simplified drawing that illustrates two of the many neurons in the network and one interconnecting weight. The two neurons 250 and 254 are connected by weight 252. In one example, the neural network is made-up of neurons such as 250 and 254, which are elemental neurons controlled directly by the information flow through the neural network and not under control of a program that defines a network in layers. Alternatively, the neurons may be independent processing units defined in hardware and configurable to the processes described. Reference 256 illustrates the functions of each neuron during forward propagation of the neural network and reference 258 represents the functions of each neuron during back propagation. The forward propagation functions of each elemental neuron include (a) the summation of the product of the weights multiplied by the output(s) of the upstream neuron(s), (b) the detection that all the products of the input weights to the neuron have been received, (c) the activation function of the neuron, and (d) the output which is the result of the activation function operating on the summation of the products provided by the weights.

The direction of information flow during forward propagation in this example is from neuron 250 through weight 252 to neuron 254 and then to the output of neuron 254. In this example neuron 250 is upstream of neuron 254 and neuron 254 is downstream of neuron 250. While two neurons are shown, it is understood that the neural network could have many or even thousands of neurons, and each neuron could have many or thousands of connections through weights to upstream neurons (unless the connection is directly to an information input, or input neuron) and each neuron may have many or thousands of connections from its output to weights leading to downstream neurons (unless it is an output neuron providing an information output, which in many examples do not have downstream neurons). For example, the operation of neurons 250 and 254 are representative of the operation of neurons 176 and 177-191 shown in FIG. 9.

In operation, neuron 250 provides its output, weight 252 detects this available output and the weight 252 multiplies that output by its weight value to create a product that is provided to neuron 254. Other neurons (not shown) similar to neuron 250 upstream of neuron 254 are connected to neuron 254 by weights. Those other neurons provide their outputs to other weights (not shown) which operate like weight 252 to provide the product of the neuron outputs and the respective weight values to the input of neuron 254. Within neuron 254 each provided product is summed to the other provided products. Neuron 254 contains a trigger function that detects when all the available products from the connected weights are provided to neuron 254. Once all the weight products are received in neuron 254 and summed the result of this summation is provided through the activation function of neuron 254. The activation function in neuron 254 may be any activation known to those skilled in the art and selected by the neural network designer. The result of the activation function is the output of neuron 254 represented by the letter O in the operations 256. In this manner, each weight in the neural network self-activates and each neuron in the neural network self-activates when the signals are available from their respective upstream sources. That is, weight 252 activates when the output is available from neuron 250. And neuron 254 activates when all of the products from all of the weights connecting neuron 254 to its upstream neurons provide their products to the input of neuron 254. Similarly, the output of neuron 254 triggers the activation of the weights connected from the output of neuron 254 to the next (downstream) neurons in the information flow.

During training information flows not only in forward propagation from neuron 250 through weight 252 to neuron 254, but also in back propagation from neuron 254 through weight 252 to neuron 250 for error correction. The information flow during back propagation similarly operates in a self-activation manner as during forward propagation. For example, each neuron calculates a delta which will be described further below and provides that delta to its input weight. So in the case of neuron 254, during backpropagation, it provides a delta to the weight 252. When the weight 252 senses that the delta is available for neuron 254, weight 252 multiplies the value of that delta by the value of the weight 252 to provide an error signal to neuron 250. Neuron 250 multiplies that error signal by the derivative of its output and sums the result of that product along with the product from any other weights similarly connected to neuron 250, keeping in mind that the illustration is a simplified illustration of two neurons but in practice weight 250 has multiple weights similar to weight 252 each connected to a respective downstream neurons. When all the errors are received in neuron 250 by weights such as weight 252 and summed together, trigger function in neuron 250 provides a delta is the result of the feedback function for that neuron. Thus in the flow of information during feedback the availability of the delta from the neuron such as 254 triggers the weight 252, which provides the error to neuron 250, which when it receives all of the errors from its respective weights computes the delta to provide to its upstream neurons through its input weights.

Also during feedback, the weight computes its adjustment in a manner known to those skilled in the art but in this case is an elemental function the weight itself. For example, weight 252 multiplies the delta from neuron 254 provided during feedback by the output of neuron 250 that was provided during forward propagation and sums that product with the similar product from each piece of information in the information set during feedback. With each iteration of the information set the combined result is provided as a correction to the weight 252. The calculations to carry about the above described operations, such as to calculate the delta, error, and weight adjustments, are known to those skilled in the art as are any details not expressly described above.

In the case where the upstream neuron is an input neuron, that neuron functions to provide the input information as the output to its connected weight. Thus if neuron 250 is an input neuron its output is the input information (which may be scaled appropriately as is known in the art) and the output is provided to the weight 252 during forward propagation. During back propagation typically there is no need to calculate a delta for an input neuron.

In the case where neuron 254 is an output neuron, the error for the output neuron is computed as the difference between the actual output and the expected output of the output neuron.

Referring now to FIG. 15, this example illustrates a neural network comprising connected neurons, of which neurons 250, 254, and 270 are representative. Only the three neurons 250, 254, and 270 are shown for purposes of explanation, with the understanding that they may be part of a larger neural network that may include many or thousands of neurons. The output of the first neuron 250 provides input to the second neuron 254 through the weight 252. Neuron 270, as well as other neurons not shown, receive outputs from the second connected neuron 254, as well as from other neurons not shown. Within each connected neuron is an activation function as described above that is activated independently by the inputs provided by the outputs of its upstream neurons and connecting weights.

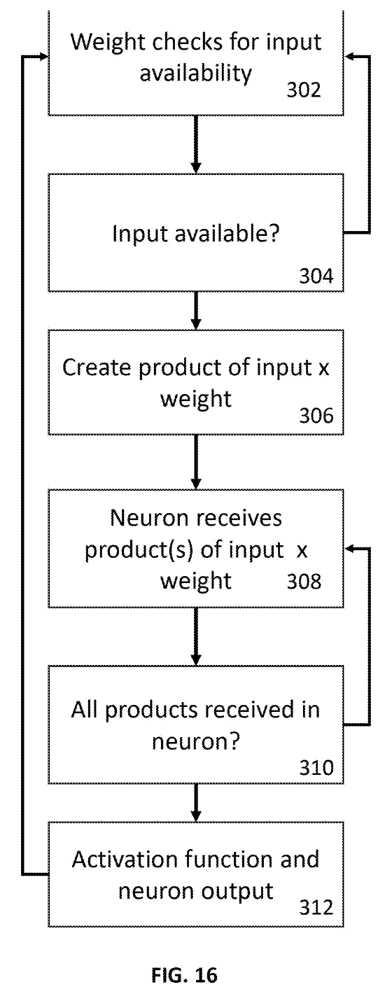

Referring now to FIG. 16, the steps shown illustrate the forward propagation steps described above with respect to the elemental neurons in FIGS. 14 and 15. Step 302 illustrates a weight checking for the availability of the output from the neuron to which it is connected to receive an output. Add step 304 if the output is available, the process moves to step 306 where the weight creates a product of that output multiplied by the value of the weight. At step 308 the weight provides that product to the neuron for which the weight is the input weight. A step 310 the neuron receiving the products of the weights and the outputs of the upstream neurons and checks whether all the products have been received, that is whether all of the input weights for that neuron have processed the outputs of the upstream neurons. At step 312 once all the products have been received the neuron processes its activation function and provides its output to its downstream neurons through their respective input weights, or in the case of the output neuron as the output of the output neuron.

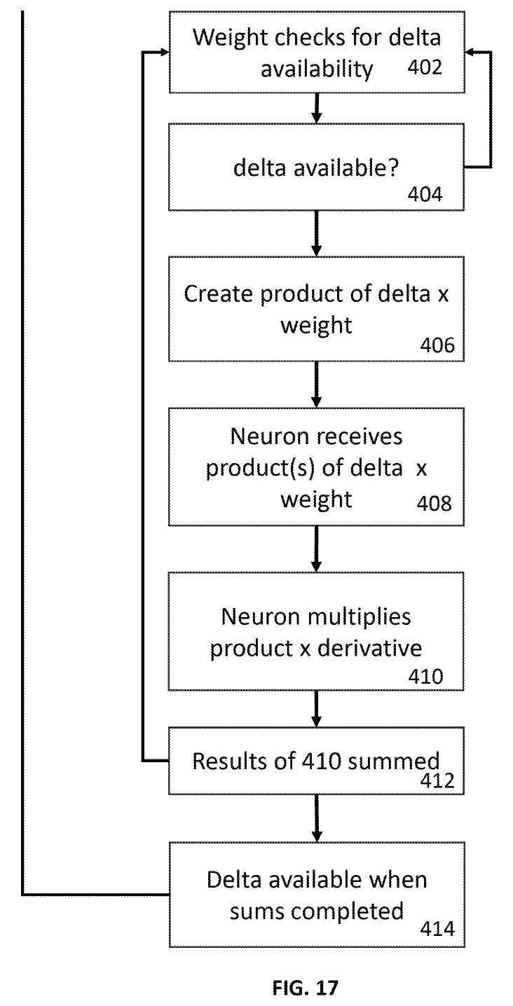

Referring now to FIG. 17, the steps shown illustrate the steps described above with respect to the feedback propagation of the neural network. At step 402, each weight checks for the availability of the delta from the neuron to which it is connected. Next step 404 determines whether the delta is available. If the delta is available, step 406 creates the product of the delta and the weight value and at step 408 provides that product to the upstream neuron as an error value. At step 410 the upstream neuron multiplies the received product by the derivative of that neuron’s output. At step 412, the results of the multiplication step 410 for all of the weights back propagating to that neuron are summed. If all of the weights providing back propagation to that neuron have not yet provided their products then the method loops back to step 402 to complete the processing of all the data from the weights connected to that neuron providing back propagation information. When all of the sums have been completed for all of the downstream weights at step 412, the neuron at step 414 provides its delta available to its input weights.

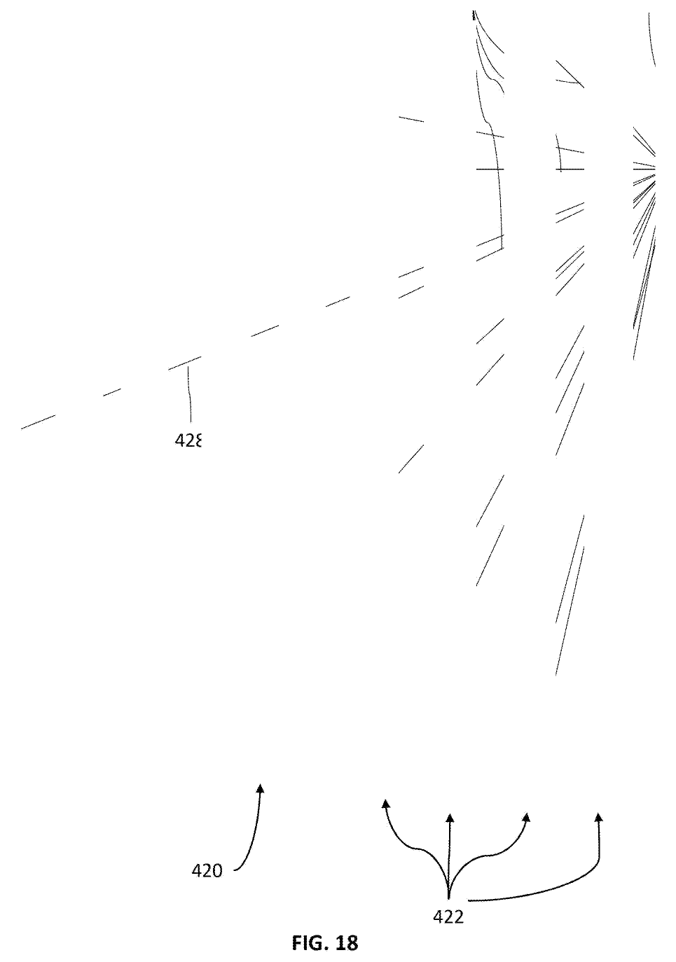

Referring now to FIG. 18, an example structure 420 for an amorphous neural network constructed from a fixed design is illustrated. This example shows 10 “layers” of neurons 422, with 12 neurons 422 in each layer. Neuron 424 is illustrated with example weights 426 connecting via stochastic sampling of upstream neurons. In this example, the max upstream depth for connection to neuron 424 is 4, with a randomized probability (e.g., 1-5%) that a long axon connection 428 reaches significantly further upstream (e.g., a depth of 9 is illustrated). In an example a software program was constructed to build a network with this structural approach by defining layers of neurons (e.g., 10 layers of neurons not including the input neurons and one or more output neuron, with each layer having 12 neurons). The software then randomly assigned a target number of weights for each neuron, such as neuron 424, to neurons in the upstream layers (to the left in this illustration), with a small chance (in examples, randomized chance of 1, 2 and 5% were used) that an individual weight would reach a neuron up to a long axon depth upstream of the neuron being processed, such as weight 428. As one skilled in the art would appreciate, for layers below the max upstream depth (e.g., layers 1 – 3 in this example), the distribution of weights would only be among the available layers. In one variation the number of input and output connections for each neuron 422 is fixed. In one example, that fixed target would be 24 for this amorphous network. In another example, the number of input and output connections are randomly assigned for each neuron 422. The number of input connections may be equal to the number of output connections on each neuron 422, or they may be different, with each randomly assigned. The entire set of neurons through the output are assigned weights this way.

Consequently, the initial geometric relationship between successive layers is dissolved, rendering the network functionally amorphous. The original 'layers' no longer dictate the order of operation; instead, each neuron is assigned to a Fluidic Layer based on its specific causal sequence as information propagates. Due to the stochastic nature of the assembly, neurons may migrate across fluidic layers (and some may need pruning if they have no input or output connections), and the final count of fluidic layers may differ from the initial scaffold. This structural approach significantly enhances resolving capability in deep, very-deep, and ultra-deep configurations.

As will be understood to one skilled in the art, FIG. 18 illustrates the upstream connections of neuron 434. The upstream and downstream connections are omitted for ease of viewing the illustration, but are included for each of the neurons in the example amorphous network shown. One variation of the neural network in FIG. 18 is to vary the max upstream depth for different starting layers of neurons 422. In one example, the max upstream depth is smaller further downstream in the amorphous network.

Thus in the example in FIG. 18, the defined limits include predetermined starting sizes of layers of the neurons 422 in the neural network, wherein the unconstrained connections are randomly connected to prior layers, wherein the unconstrained connections provide the amorphous shape to the operations of the fluidic layers. In another example, the defined limits include the max upstream depth of stochastic input connections to the neurons 422. In another example the defined limits include long axon depth and the ratio limit of long axons weights to total weights. In one example, the ratio limit is in a range of 1 – 5%.

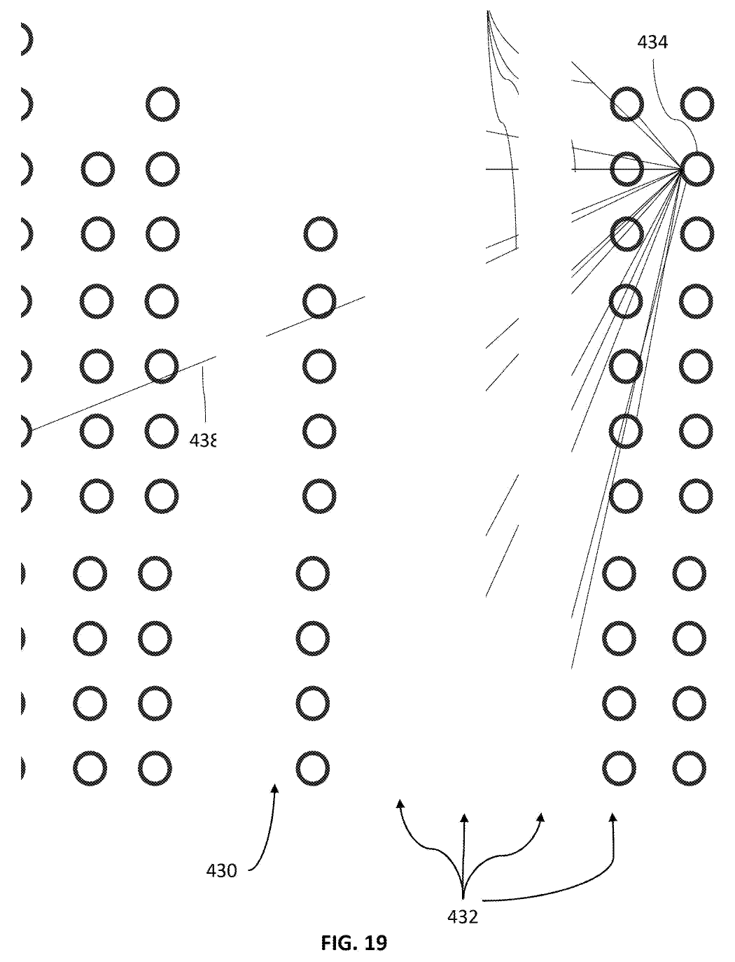

Referring now to FIG. 19, an example amorphous neural network core 430 is shown. The network core 430 comprises neurons 432, with most connections omitted, except for connections 436 and 428 to neuron 434. This example differs from the prior example in that the number of neurons in each “layer” of the reference design is randomly varied within a range. In this illustration, the number of neurons in each “layer” varies from 9 to 12. Except for this variation, the remainder of the network is constructed as in the example in FIG. 18. Varying the layer size may provide performance improvements in some very deep and ultra-deep configurations.

In either of the examples in FIG. 18 and FIG. 19, the resulting neural network will have fluidic layer sizes statistically bounded within a specific range for given lengths of the network. This will be true for the portions of the networks shown in FIG. 18 and in FIG. 19. Thus one of the defined limits of the networks shown is the statistically bounded fluidic layer sizes resulting from the structures shown for the portions of the amorphous neural network in which they are implemented.

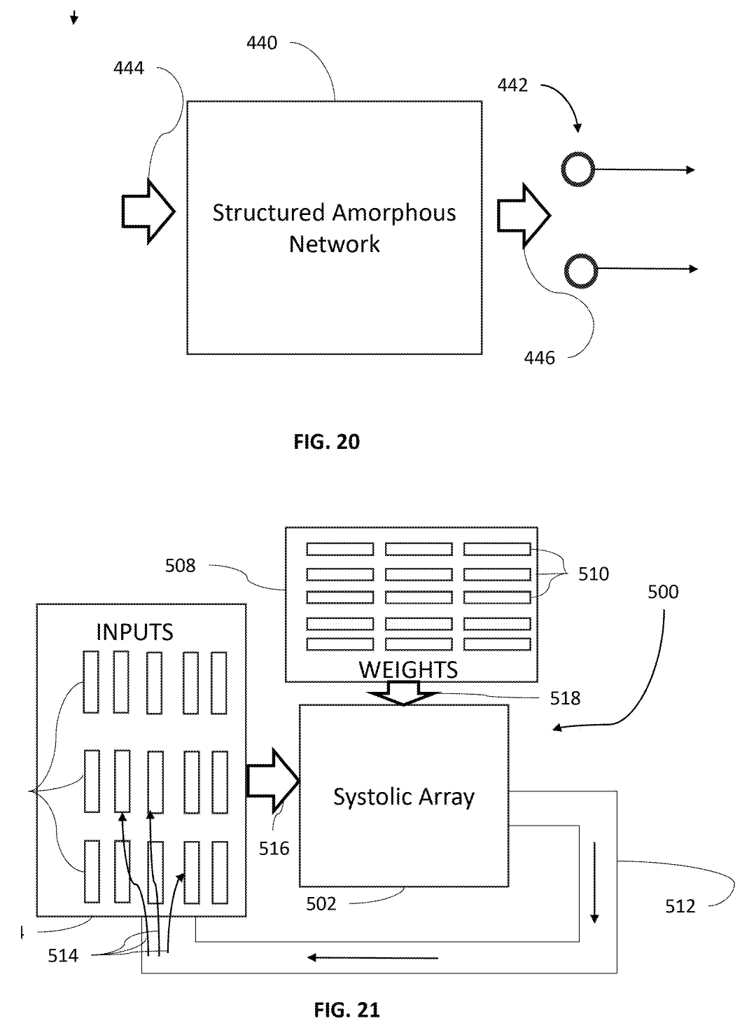

FIG. 20 illustrates an example amorphous neural network including input neurons 102, output neurons 442 and a structured amorphous network 440 which may be, for example, either of the examples shown in FIG. 18 or 19, or variations thereon. To avoid clutter, the individual connecting weights from the input neurons 102 are shown collectively as reference 444 and the individual weights connecting to the output neurons 442 are shown collectively as reference 446. One skilled in the art will recognize that these represent individual connections of the type described herein.

In a traditional neural network, though it is not necessary, it is preferable in many implementations to process the math for each layer of the network through one or more tensor processors, which are matrix math units that may be implemented as part of a larger system for processing the neural network. Example known implementations of tensor processors are constructed for the isomorphic symmetries of classical neural networks. They facilitate the fixed layer design approach (with and without resnet and other known variations) of classical neural networks.

In an amorphous network, the relationship of each neuron to upstream neurons is fluidic, as are the fluidic layers that represent the parallel steps for processing through the amorphous network. To address this structural divergence, a fluidic tensor processor is provided – a hardware engine optimized for topological resolution rather than predefined geometric grid-math.

FIG. 21 illustrates an example fluidic tensor processor 500. Reference 502 represents a parallel operation math unit, such as a systolic array that is representative of the matrix multiplication unit found commonly in tensor processors. In generic operation of a prior art tensor processor (not shown) the inputs to the processor during a layer calculation are 1) the activation outputs of the prior layer, stored in a buffer or local memory adjacent to the systolic array and 2) the specific weight matrix for the current layer. The processor performs synchronous matrix multiplication to generate the output, which serves as the static input for the calculation of the next layer, along with the weights of the next layer.

An example improvement, illustrated in FIG. 21, defines an input memory architecture. In this embodiment, the input memory 504 is partitioned into a plurality of causal buckets 506, each representing a subsequent fluidic layer of the amorphous network. Because a neuron’s output may interface with multiple non-adjacent downstream stages, the output from a given fluidic layer is asynchronously routed to specific memory buckets based on their causal dependencies.

In an example, the gating of outputs to causal buckets is implemented via a causal dispatch logic. Each fluidic layer output is associated with a target address list corresponding to downstream buckets. Upon the resolution of a fluidic layer, a distribution fabric (such as a crossbar or bus) routes the resulting activations to the designated addresses. This routing occurs asynchronously, allowing data to 'skip' intermediate buckets and populate 'long-reach' or 'axon' buckets deeper in the memory architecture. This process ensures that data is disseminated based on its topological destiny rather than a rigid geometric sequence.

This routing is represented graphically by references 514. Upon completion of a compute cycle, the processor dispatches the output signal to all designated bucket addresses simultaneously. When a bucket reaches input saturation (i.e., it has received its full quota of expected inputs), it triggers a data-driven execution cycle within the systolic array (the data transfer bus represented by reference 516). Link addresses concurrently fetch the corresponding weight array (whose transfer to the parallel operation math unit 502, such as a systolic array, is represented by reference 518), enabling the fluidic layer to perform a synchronous matrix multiplication at the precise moment of causal readiness. If there are long reach axon connections beyond the number of causal buckets, the corresponding outputs may be stored in staging memory (or ancillary memory) or an overflow buffer until the causal bucket for the correct fluidic layer becomes ready.

A first example approach is asynchronous. Software signals define the input quota for each causal bucket 506. Upon receiving a number of upstream signals equivalent to this quota, the bucket 506 is automatically dispatched as the next operand for the parallel operation math unit 502, concurrently fetching its associated weight array for event-driven execution.

In a second example approach, the execution sequence is deterministic. A software algorithm pre-calculates the size and order of each fluidic layer by analyzing the causal dependencies of every neuron—specifically, assigning each neuron to a position of VLₙₑₓₜ = VL_{max_parent} + 1 relative to its deepest upstream parent. One skilled in the art can create this algorithm utilizing the information herein. This pre-determined sequence allows the fluidic layers to be cycled through the input memory in a high-speed shift-register fashion, maximizing hardware utilization. In this example, the memory map for distribution of the output signals to the appropriate causal buckets 506 is updated automatically with each cycle through the fluidic tensor processor 500.

In the examples above, the parallel operation math unit 502 is a systolic array. In another example for a one bit network, the systolic array can be simplified to a binary logic unit, since the weight multiplications are simplified.

The examples discussed below each used 4.25 years of daily financial stock data (1582 rows). Each entry featured 310 input neurons. By using a single-stock dataset, the tests create a focused environment to measure convergence efficiency, demonstrating the resolution capability of a dense, noisy, and high-entropy signal. In each example amorphous network below, unless otherwise noted, the network was still converging when the target accuracy was reached. This indicates that the "fluidic" architecture hasn't just found a solution—it's still actively optimizing.

### Example: Amorphous Network from Fixed Design – Deep Narrow Network

Deep networks have trouble learning because of a vanishing gradients. Take for example a conventional fully connected neural network having 26 neurons per layer and 101 layers, with the final few layers tapering down to a single output neuron. Even using optimization techniques known in the art, it is unlikely that the network will resolve the training set due to vanishing gradients. As would be expected by one skilled in the art, in an example implementation, this network did not make progress resolving a test data set after several dozen epochs.

Now add a resnet structure as known in the art with a skip length of 10 to the 101 layer network. So each neuron in layer l above layer 10 has 52 input neurons, 26 to the immediately preceding layer and 26 to the skip length preceding layer. It may learn slowly because the resnet skip layers allow paths past the vanishing gradient neurons. In one example, the network took over 100 epochs to learn 90% of the test data set (which is the same set used in the above example). Repeating the example with skip length at 5 and again at 1 resulted in both networks not learning.

Now convert the layers connections to amorphous connections in accordance with an embodiment of this invention by randomizing the assignment of the input weights to each neuron to upstream neurons from a random set of upstream layers. In one example, set the max depth equal to 10, so it is the same max depth as the 10 skip length resnet example. Also allow a 1% chance that an input weight reaches a “long axon” depth, in this example of up to 15. That is, with the input weight assignments, 1% are given an upstream depth randomly picked between the max depth and the long axon depth. Also randomized is the number of input weights for each neuron. In one example, a target count for a neuron in layer l is set to the number of neurons in l-1 added the number of neurons in l – max depth. Then a number is randomly picked between target count/2 and 1.5 x target count for each neuron. In this example there are no fully connected layers and no fully connected resnet skip layers. The resulting neural network is amorphous with fluidic layers that defy classical definition, even though it started from a “shape” of 26 neurons per layer with the last few layers tapering down to the output neuron. Classical neural networks have a geometric relationship between layers, allowing layer calculations to be dot products with other layers. This is a geometric operation (calculating the cosine of the angle between two vectors). Thus a classical network is a series of geometric transformations based upon defined layers. In contrast, the amorphous network of this example is topologically fluid removing the shape of the layer connections in the classical network. By replacing geometric certainty with probabilistic connectivity, the amorphous network eliminates the rigid 'information friction' that causes vanishing gradients in deep, thin architectures. In an example test of this neural network with amorphous layers, the network demonstrated significantly improved convergence velocity, reaching 90% training accuracy in 11 epochs, using the same test data set used in the resnet example. The network was still converging when training was stopped. This illustrates the benefits of layers having no shape (fluidic layers), or amorphous layers, in processing information in a very deep neural network.

### Example: Amorphous Network from Fixed Design – Deep Wide Network

In an example, tests similar to the previous example were conducted on a fully connected neural network with 250 neurons per layer, 101 layers deep, with the final few layers tapered down to a single output neuron. As would be expected by one skilled in the art, this conventional fully connected neural network did not make progress resolving the test data after several epochs.

In an example, the 250 neuron per layer, 101 layer deep network was structured with resnet skip length of 10. So each neuron in layer l above layer 10 has 500 input neurons, 250 to the immediately preceding layer and 250 to the skip length preceding layer. The wider network provides more potential paths inherently making it easier to learn data than the 26 neuron per layer network. In an example test, this network reached a 90% training accuracy in 27 epochs.

In another test example, according to this invention, the layer connections are converted to amorphous connections using the same techniques as in the 26 neuron per layer example above. The max depth was set to 25 (layers/10) and the long axon depth was set to 125 (5* max depth). In an example test, this network demonstrated a significantly improved convergence velocity, reaching a 93% training accuracy on the same test data set in 6 epochs. The network was still converging when training was stopped. This further illustrates the superior learning capacity of amorphous structures in very deep networks, where rigid geometric layers are replaced by fluidic, probabilistic connectivity.

### Example: Amorphous Network from Randomization of Fixed Design – Deep Narrow Network

In an example, neural network is constructed of 101 layers, with each layer having a random number of neurons in the range 15 to 29, with the final few layers tapered down to a single output neuron. Each layer is fully connected to the previous layer. As would be expected by one skilled in the art, in an example test with the same test data utilized in the above examples, the network did not make progress resolving the test data after several epochs.

In an example, a neural network constructed using the same process as above, with each layer having a random number of neurons in the range of 15 to 29. Each layer is fully connected to its neighboring layer and now has resnet connections with a skip length of 10, in the same manner as in the prior resnet examples. In an example test, this network made progress resolving the test data, but reached a training accuracy of under 70% in 100 epochs, using the same test data set.

Next, in an example according to this invention, the layer connections are converted to amorphous connections in the manner described above. In an example test, this network reached a training accuracy of 90% in 13 epochs.

### Examples: Amorphous Network Randomized Design

In an example, a neural network is constructed with sequential amorphism as follows. The structure starts with the input neurons and a set of 2000 additional neurons not yet connected to other neurons. Neuron connection limit is set to 52 for both the inputs and the outputs. This makes the size of the network roughly comparable to the network that started with 110 layers and 26 neurons per layer above. During construction, as neurons are assigned connections, each new neuron has 52 weights randomly connected to the entire history of the network with assigned connections as the potential input neurons. So the first neuron to get processed randomly connects 52 weights to neurons selected from the set of input neurons. The second neuron looks to the combined set of the input neurons and the first neuron and randomly selects 52 connections from that combined set. The third neuron looks to the combined set of input neurons and the first and second neurons and randomly selects 52 connections from that combined set. The software controls the chronological connection strategy to build the network in this manner, essentially allowing each new neuron to sample the entire causal history of the system (except neurons whose output counts have hit their limits). Since the connections are random, some neurons become dead ends and are pruned from the network. In this example, no constraint is put on depth of potential “long axon” connections. Since the connections are random, some connections are naturally “local” (neurons more near upstream to the neuron in question) and some are naturally longer (neurons further upstream to the neuron in question). In an example using the same test data from the above examples, the network reached a training accuracy of 90% in 5 epochs, and 100% in 16 epochs.

In an example amorphous neural network similar to the immediately preceding example, the neuron connection limit is stochastically assigned for each neuron. The input and output limits are determined individually by a range of ±50% of the default value (e.g., a range of 26 to 78 connections for a default of 52). This structural variation allows for substantial heterogeneous signal density across the network. In testing of this example, the network reached a training accuracy of 90% in 4 epochs and 100% in 17 epochs.

In another example amorphous neural network similar to the immediately preceding example, the pool of available neurons is limited with a recency constraint. Once a predefined threshold (e.g., 25% of the total neuron population) has been processed, a First-In, First-Out (FIFO) Eligibility Buffer approach is utilized. For each subsequent neuron integrated into the topology, the oldest neuron in the processed pool is decommissioned from the eligibility list. This effectively enforces a Sliding Window of Connectivity, limiting the 'back-reach' of deeper neurons and requiring hierarchical information consolidation. In other words, this structure enforces more information processing as data reaches later stages of the network. In a test with data in this example amorphous network, the network reached a training accuracy of 90% in 4 epochs and 100% in 12 epochs.

In another example amorphous neural network similar to the immediately preceding example, the pool limit is set to 15% of the total neurons. Thus, once 300 neurons have been processed, for every neuron that enters the pool of eligible neurons for source connection to the neuron in question, the oldest neuron in the pool is dropped form the pool. A test data run of this example amorphous neural network reached a training accuracy of 90% in 5 epochs and 100% in 14 epochs.

In another example amorphous neural network similar to the preceding examples, the neuron pool was set to 6000 neurons. The pool limit was set to 15% of the total neurons. The resulting network had 951 fluidic layers, giving the network an effective length to width ratio of 150:1. A test data run of this example amorphous neural network reached a training accuracy of 90% in 6 epochs and 100% in 13 epochs.

In another example amorphous neural network similar to the preceding examples, the neuron pool was set to 10000 neurons. The pool limit was maintained at 15% of the total neurons. The resulting network had 1362 fluidic layers and reached a training accuracy of 92% in 18 epochs. With the amorphous pool scaled to 10,000 neurons, the system naturally organized into 1,362 fluidic layers. In a classical setting, a network of this depth would be virtually untrainable. However, by maintaining a 15% sliding window of connectivity, the network reached 92% resolution in just 18 epochs. This demonstrates that amorphous connectivity doesn't just work for small prototypes—it scales to ultra-deep architectures without hitting the 'gradient wall' that stops traditional models.

### Example Very-Deep Amorphous Network from a Fixed Design

In an embodiment of a very-deep amorphous neural network, an initial scaffold of 1,010 layers and a random variation of 15-29 neurons per layer was established. The primary connection depth was set at 101 (Layers/10), with 'long axon' connections extending to a maximum depth of 151 (1.5 * max depth). Following the stochastic connection and pruning processes described herein, the resulting network comprised 22588 active neurons across 670 fluidic layers. Fluidic layer size ranged from 19 to 63 neurons. In an example test, the model reached a training accuracy of 75% after 44 epochs, at which point testing was terminated.

The examples above illustrate the benefits and feasibility of amorphous neural networks for high power work loads and for extending the reaches of neural networks beyond current limits. The increased convergence velocity, or learning speed, in the examples shown above illustrate potential efficiency gains by implementing amorphous neural networks, along with potential reduced cost and energy consumption. They may be adapted to any form of neural network, including but not limited to in autoencoders, recurrent designs, convolutional design, and others.

In addition, amorphous neural networks may be integrated into hybrid architectures. In one embodiment, a classical wide-layer network is utilized for initial feature extraction or categorization, the output of which is then routed into a deep amorphous network. This configuration leverages the broad parallel processing of classical designs for initial data reduction while utilizing the extreme causal depth and topological resolution of the amorphous network to extract higher-order intelligence from those features.

The addition of the fluidic tensor processor means that current technology can be adapted to work with these improvements. In large-scale implementations, computational efficiency is often maximized by maintaining uniform workload sizes. While the fluidic layers in an amorphous network are inherently non-uniform, the 'fixed scaffold' approach described in many of the examples herein ensures they remain statistically bounded within a specific range. This allows for the use of null filling (zero-padding) to simulate uniform layer sizes, enabling the processor to maintain peak throughput and high efficiency while accommodating the fluidic nature of the amorphous network. This approach effectively fits the topological cloud nature of the amorphous network into the rectangular box nature of tensor processing without losing the cloud’s intelligence, providing a viable architectural path for amorphous neural networks.

As will be well understood by one skilled in the art, the methods and amorphous neural networks described above can be implemented by any number of known technologies. The neural networks and the programs for assigning weights can be coded in software using the information herein and knowledge known in the art. Additionally, the amorphous neural networks can be implemented in purpose built hardware or silicon, including but not limited to field programmable gate arrays and application specific integrated circuits, using the information provided herein and knowledge known in the art. The improvements herein are meant to work with all numerical precision and quantization formats used in neural networks, including but not limited to eight bit (FP8), four bit (INT4), and one bit (binary) implementations.

1. A neural network comprising multiple neurons including a subset of neurons comprising a majority of the multiple neurons, wherein each neuron of the subset of neurons has upstream neurons and downstream neurons connected through connections in a manner such that the connections for each neuron to other neurons are unconstrained within defined limits so that a relationship between consecutive processing layers is non-isomorphic and amorphous and is capable of at least one of learning information and outputting learned information, wherein each neuron in the subset of neurons has input connections and the input connections to the each neuron are stochastically distributed to upstream neurons at multiple upstream depths.

2. A neural network according to claim 1, wherein the defined limits include at least a maximum number of input connections to each neuron of the subset of neurons.

3. A neural network according to claim 1, wherein the defined limits include at least a minimum number of input connections to each neuron of the subset of neurons.

4. A neural network according to claim 1, wherein the defined limits include at least a maximum depth upstream of an added connection for a neuron of the subset of neurons.

5. A neural network according to claim 2, wherein the maximum number of input connections for a neuron of the subset of neurons varies in relation to a downstream depth of the neuron in the neural network.

6. A neural network according to claim 1, wherein the neural network is a deep neural network.

7. A neural network according to claim 1, wherein the neural network is an ultra-deep neural network.

8. A neural network according to claim 7, wherein the ultra-deep neural network has at least 100 fluidic layers.

9. A neural network according to claim 7 wherein the ultra-deep neural network has over 1000 fluidic layers.

10. A neural network according to claim 1 with a depth to width ratio greater than 10.

11. A neural network according to claim 1 with a depth to width ratio greater than 50.

12. An amorphous neural network built from a predetermined reference design characterized by non-isomorphic layer relationships achieved through stochastic distribution of weights to upstream neurons across a plurality of variable upstream depths.

13. A fluidic tensor processor comprising a parallel operation math unit and input memory holding data from a prior output calculation in multiple causal buckets each of which is associated with a distinct fluidic layer, wherein each causal bucket is linked to a specific weight array for concurrent dispatch to the matrix math unit.

14. The fluidic tensor processor of claim 13, wherein the parallel operation math unit is a matrix math unit.

15. The fluidic tensor processor of claim 13, wherein the parallel operation math unit is a binary logic unit.

16. The fluidic tensor processor of claim 13, wherein the concurrent dispatch is triggered asynchronously for each causal bucket and its linked weight array upon said each causal bucket reaching a predetermined signal limit.

17. A fluidic tensor processor of claim 13, wherein the concurrent dispatch of each causal bucket and its linked weight array is triggered in a predetermined order based upon a fluidic layer assignment of the each causal bucket.
